(19) United States
(12) Patent Application Publication
(10) Pub. No.: US 2024/0225791 A1
(43) Pub. Date: Jul. 11, 2024

(54) GEOMETRY OF A SCREW FOR IMPLANTS

(71) Applicant: UNIVERSIDAD NACIONAL DE COLOMBIA, Bogotá, D.C, (CO)

(72) Inventors: Jennifer Paola Corredor Gómez, Bogotá (CO); Carlos Julio Cortés Rodríguez, Bogotá (CO); Miguel Alejandro Gamboa Márquez, Bogotá (CO)

(21) Appl. No.: 16/634,131

(22) PCT Filed: Jul. 25, 2018
(86) PCT No.: PCT/IB2018/055523

§ 371 Date: Mar. 30, 2022

(30) Foreign Application Priority Data
Jul. 25, 2017 (CO) 20170007376

(51) Int. Cl. A61C 8/00

(52) U.S. Cl. CPC A61C 8/0045

(57) ABSTRACT

A screw for dental implants whose geometry was designed from nine parameters (diameter, length, body angle, pitch, coronal thread angle, apical thread angle, apical rounding, thread width and thread depth) that allow to calculate the distribution of its mechanical load. This geometry allows the distribution of efforts to optimize bone remodeling and improve osseointegration.

This application is a 371 application of International Application No. PCT/IB2018/055523 filed Jul. 25, 2018; (published on Jan. 31, 2019 as WO2019021193) titled “Geometry Of A Screw For Implants”; the entire contents of which are hereby incorporated by reference herewith. This application also claims priority to Colombian Application No. C020170007376 filed Jul. 25, 2017.

### FIELD OF THE INVENTION

The present invention relates to bone implants, particularly but not exclusively, the dental implants area.

### BACKGROUND OF THE INVENTION

An implant is a medical device manufactured to replace a missing biological structure. In the case of dental implants, the screws are used to replace the function that the tooth root naturally performs: giving support and stability.

Currently, there is a wide variety of commercial designs for dental implant screws. Mostly self-tapping dental implants, however, it is also possible to find implants that are axisymmetric and non-self-tapping. (Bicon, 2017) (3i, 2017) (Straumann, 2017), (Zimmer-Biomet, 2017).

Three facts entail the need to improve current dental implants:
1. The human body is naturally designed to function for a certain period of time, however, positive changes in lifestyle can extend that time. On average, the global life expectancy has increased (Banco Mundial, 2016).
2. The loss of dental pieces is notable in elderly patients (Misch, 2007).
3. Other probable causes of loss of dental pieces may include: accidents; poor hygiene; and, pathological conditions.

Due to the different causes for the loss of dental pieces and the proportional relationship between age and edentulism, the growing need for dental implants is undeniable.

### Consequences of Edentulism

The percentage of bone loss is 25% during the first year after the loss of the bone piece, then decreases, but never stops (Persson, 1967) (Tallgren, 1966) (H Gruber, 1996). According to the above, the bone will have a lower volume and density over time. The loss of dental pieces causes anatomical changes such as, for example, the decrease in the height and width of the support bone. These changes increase the risk of fracture. The anatomical impacts generated in patients, due to the loss of dental pieces, also induce psychological consequences.

The use of dental implants, to replace dental pieces, can prevent bone loss. Through the screw for dental implants, the loads necessary for bone remodeling can be transmitted to the bone. Research shows that there is an increase in bone density due to the use of prosthetic implants, although dental implants are a solution for dental absence, they do not completely replace the natural functionality of the tooth.

Bone tissue is anisotropic and not homogeneous. Osseointegration is defined as the functional connection between an implant and the bone without the intervention of soft tissues (Waldemar Mroz, 2015). The factors that directly affect osseointegration are: The geometry of the implant; the load application; the surface of the implant; the implant material; and, bone quality (Ha, 2009).

The computational modeling of the bone remodeling process allows an approach to possible responses to different parameters. In the case of dental implants, the geometric characteristics affect the distribution of mechanical load, which in turn stimulates the bone remodeling process. In this way, it is possible to perform a comparative analysis of the macro and meso geometry of commercial implant screw geometries, in order to know the effects on the bone surrounding the bone implant. (Jennifer Paola Corredor-Gómez MA-M.-R.-A., 2012), (Jennifer Paola Corredor-Gómez CJ-R., 2013), (Jennifer Paola Corredor-Gómez ML-D.-R., 2014) (Jennifer Paola Corredor-Gómez, 2015) Dental implant placement protocol Implant placement protocol has two stages. The first one refers to a period of three to six months since the implant has been placed. In this phase, also called static phase, the protocol indicates that mechanical loads must be avoided in order to generate an appropriate osseointegration (Luigi Baggi, 2008).

Then in the second stage, also known as the dynamic phase, functional loads are applied. In the case that there are movements between the implant and the bone, it means that the formation of new bone tissue was not successful and that therefore fibrous tissue was formed, meaning that osseointegration failed (Hsuan-Yu Chou, 2008) y (Arturo N. Natali, 2007). Two key biological processes have been identified to achieve osseointegration: bone wound healing, and bone tissue remodeling (See FIG. 4).

Primary stability is given by the mechanical adjustment between the bone that was before the placement of the implant and the screw of the implant. In this period the reabsorption of old bone begins, some authors call this process bone remodeling (Senichi Suzuki, 2013), but the nature of the process could imply that reabsorption occurs due to the necrosis of the surrounding bone tissue and probably later wound healing process is presented.

Although the formation of new bone starts quickly, it does not ensure secondary stability. Secondary stability begins after the new bone begins the remodeling process.

Bone remodeling process occurs in both trabecular and cortical bone. Bone remodeling has been defined as: “a coordinated action between osteoclasts, osteoblasts, osteocytes and bone matrix with descendants of osteoblasts that cover the surface of the bone” (Gooi, 2008). Bone remodeling is a complex process in which cells of different types, extracellular matrices and biochemical substances interact to optimize bone structure. This process is activated according to the mechanical stimulus to which the bone is subjected. The bone density changes over time according to the amount of mechanical stimulus to which it is subjected (Wolff, 1893).

The cells directly involved in the remodeling process come from two lineages, mesenchymal cells and hematopoietic cells. Bone remodeling process begins with mechanotransduction, a phenomenon in which osteocytes play a fundamental role, acting as embedded sensors within the bone matrix. Osteocytes are sensitive to microdeformations generated by mechanical loads. Depending on the load, the osteocytes produce biochemical signals that induce bone remodeling process.

Due to the nature of the dental implants, these will be subject to chewing loads. In order to stimulate the remodeling process of the new tissue, the mechanical load application conditions must be improved, for this, geometries that guarantee and regulate a concentration of efforts that positively stimulate the new bone formed must be considered.

It must be taken into account that not all mechanical loads increase bone density. The absence of load generates bone resorption. The lack of regular masticatory loads is the reason why there is bone resorption in patients with edentulism.

There are mechanical loads that do not generate microdeformations large enough in the osteocytes to activate bone remodeling process, this is called the dead zone or lazy zone. Most of the time the bone tissue is in this state.

Mechanical overload activates the bone resorption process, in fact, these charges are one of the major drawbacks in dental implants. These overloads occur as a result of the lack of proprioception in patients with dental implants, this due to the absence of the periodontal ligament.

### BRIEF DESCRIPTION OF THE FIGURES

FIG. 1 depicts a schematic, bottom isometric view of the screw. Numeral 1 indicates the position of zone A, that is, the most coronal section of the screw for dental implants. Numeral 2 indicates the zone B that refers to the body of the screw for dental implants. Numeral 3 indicates the position of zone C, that is, the most apical zone of the screw for dental implants.

FIG. 2 depicts a schematic, frontal view of the screw. Numeral 4 indicates the crest of the thread, that is, the outermost part of the thread. Numeral 5 indicates the thread valley, which is the innermost part of the thread, some authors name this section as the screw core for dental implants. Numeral 6 indicates the coronal flank of the screw thread for dental implants. Numeral 7 indicates the apical flank of the screw thread for dental implants.

FIG. 3 depicts a schematic, placement of the screw for dental implants in the bone. The axis indicates the revolution of geometry. It should be noted that the screw for dental implants is axisymmetric. Numeral 8 indicates the screw for dental implants. Numeral 9 indicates the portion of cortical bone. Numeral 10 shows the new bone that formed once the wound healing process was over. Numeral 11 shows the portion of trabecular bone.

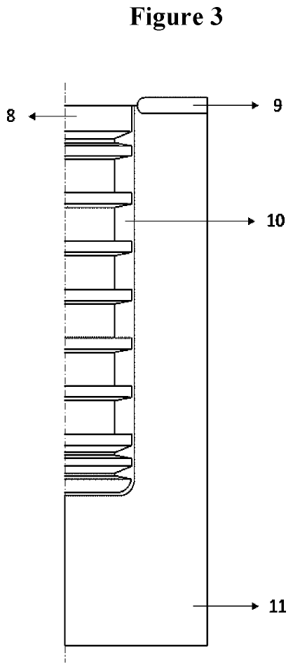

FIG. 4 depicts a schematic, portion of new bone that was formed at the end of the bone tissue healing process due to the injury caused by the placement of the screw for dental implants. Note that the screw, as it is not self-tapping, must enter the bone longitudinally and therefore the wound is of a larger diameter than the screw. Numeral 12 indicates the dimension of the radius of the wound, calculated as 0.1 millimeters larger than the diameter of the dental implant screw.

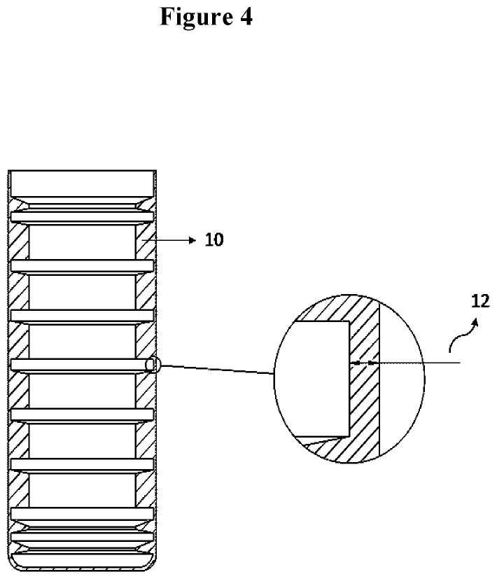

FIG. 5 depicts a schematic, frontal view of the screw for dental implants. Numeral 13 refers to the dimension: screw length for dental implants. Numeral 14 refers to the dimension: screw diameter for dental implants.

FIG. 6 depicts a schematic, frontal view of the screw for dental implants. The circle shows in detail the area A. Numeral 15 refers to the dimension: apical angle of the screw for dental implants. Numeral 16 refers to the dimension: coronal angle of the screw for dental implants.

FIG. 7 depicts a schematic, frontal view of the screw for dental implants. The circle shows in detail zone B. Numeral 17 refers to the dimension: screw thread depth for dental implants. Numeral 18 refers to the dimension: screw pitch for dental implants.

FIG. 8 depicts a schematic, frontal view of the screw for dental implants. The circle shows zone C in detail. Numeral 19 refers to the dimension: screw thread width for dental implants. Numeral 20 refers to the dimension: apical rounding of the screw for dental implants.

### DETAILED DESCRIPTION OF THE INVENTION

The screw geometry of the dental implant is defined by nine parameters:
1) diameter;
2) length;
3) body angle;
4) pitch;
5) coronal thread angle;
6) apical thread angle;
7) apical rounding;
8) thread width;
9) thread depth.

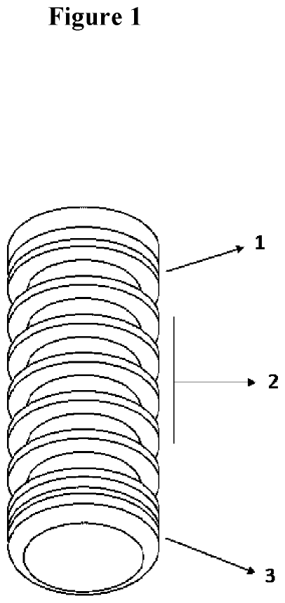

Additionally, it is taken into account that bone is a non-homogeneous material and therefore its physical properties differ according to the depth of the wound, for this reason the present invention has a geometry sectioned in three zones (see FIG. 1): A, B and C, where: a) zone A is the most coronal portion of the implant screw; b) zone B the implant body; and, c) zone C the most apical portion of the implant. Each of these areas has different physical and biological conditions and therefore the proper geometry to generate an appropriate stimulus is different.

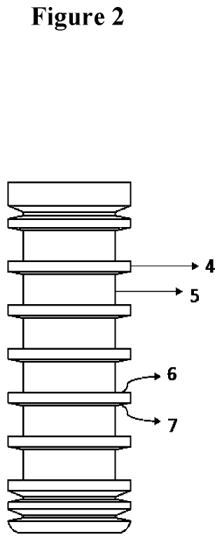

The parameters of the invention are described below, taking into account that the screw is positioned vertically as shown in FIG. 2:

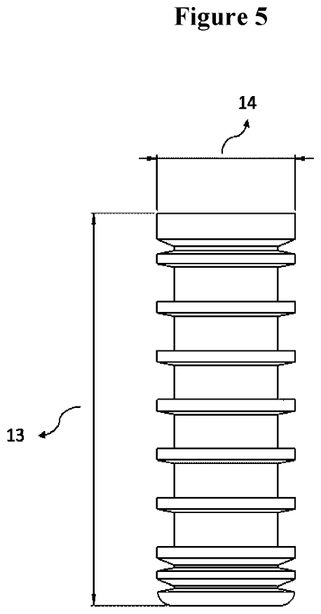

The screw diameter refers to the outer measurement of the cylinder with which the dental implant screw is formed (See FIG. 5).

The length is the vertical longitudinal measurement of the dental implant screw (See FIG. 5).

The body angle is the measure that determines the conicity of the dental implant screw. In the present invention the measurement has been considered as the angle formed between the lines that describe the crests of the implant threads and the vertical (See FIG. 2).

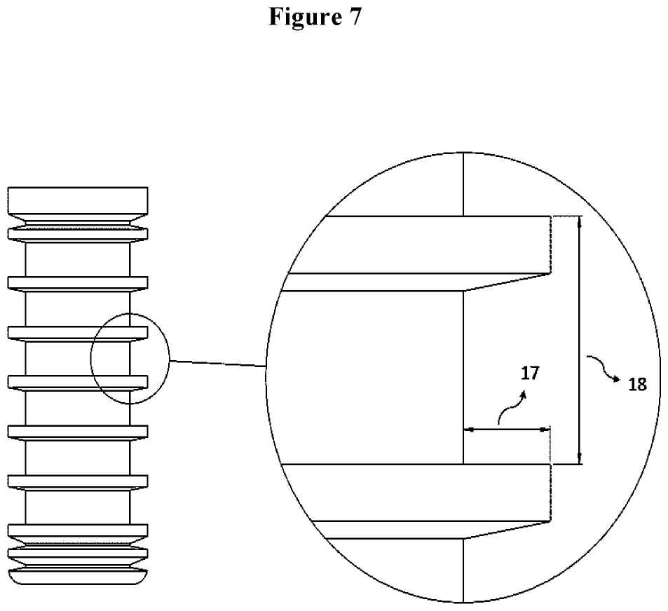

The pitch is the measurement between the beginning of a thread and the beginning of the next thread (See FIG. 7).

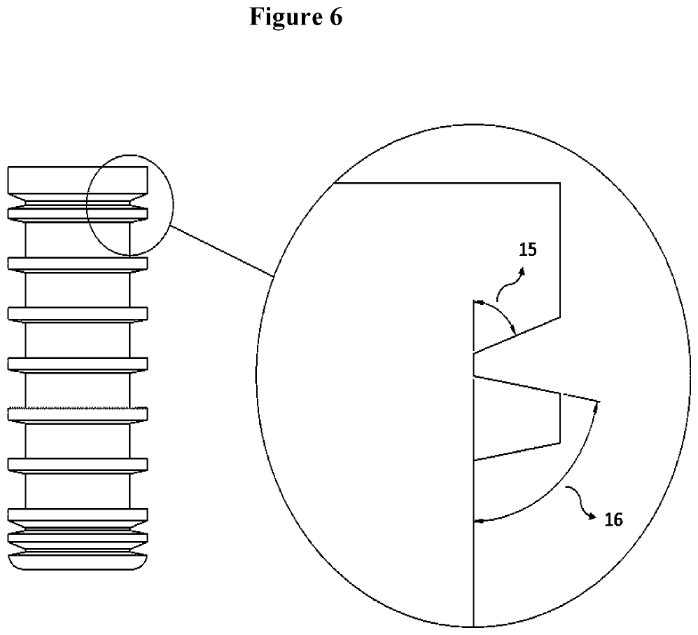

The angle of the coronal thread is measured between the coronal flank of a thread and the vertical one (See FIGS. 2 and 6).

The angle of the apical thread is measured between the apical flank of a thread and the vertical one (See FIGS. 2 and 6).

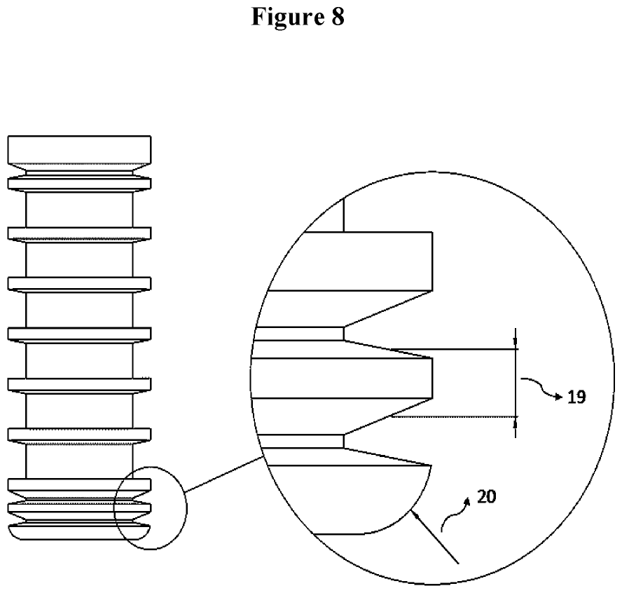

The apical rounding is the measure of the radius of the lower part of the dental implant screw, this measure corresponds to the rounding in the deepest part of the bone wound at the time of placement (See FIG. 8).

The thread width is the vertical measurement between the middle of the coronal flank of the thread to the middle of the apical flank of the thread (See FIG. 8).

The depth of the thread is the horizontal measure between the crest and the valley of a thread (See FIG. 7).

The material considered for the invention is titanium and its biocompatible alloys.

### Technical Problem

The regeneration of bone tissue depends on various factors such as the mechanical load that is rarely taken into account in integrated models.

### Solution to Problem

To consider the existence of mechanical loads in a specific range that stimulate the bone remodeling is fundamental to create geometries that guarantee and regulate a concentration of efforts can positively stimulate the new bone formed.

The present invention optimizes the process of bone remodeling through a dental implant screw geometry that favors the distribution of mechanical loads to improve secondary stability.

### Advantages of the Invention

With an appropriate geometry such as the one proposed here, efforts can be distributed to optimize bone remodeling and in turn improve osseointegration.

### Examples

A screw with the following dimensions was designed: diameter of 5 mm; length 11 mm; body angle 0; pitch 1.15 mm; 85° coronal thread angle; 75° apical thread angle; apical rounding 0.5 mm; thread width 0.4 mm; and, wire depth 0.5 mm.

### REFERENCES CITED

3i, B. . (10 de 07 de 2017). Bienvenido-Biomet-3iColombia. obtained from website: 3icolombia.com.co/.
Arturo N. Natali, E. L. (2007). Dental implants press fit phenomena: Biomechanical analysis considering bone inelastic response. DentalMaterials, 25:573-58.
Banco Mundial. (2016). World Development indications.
Bicon. (10 de 07 de 2017). Bicon-Colombia-Implantes Dentales Bicon. Obtained from web site: bicon.com.co/
. Gooi, N. A. (2008). Bone remodeling: Multiple cellular interactions required for coupling of bone formation and resorption. Seminars in Cell and Developmental Biology, 19(5):444-451.
H Gruber, P. S. (1996). Maxillomandibular anatomy and patterns of resorption during atrophy. Edosseous Implants: Scientific and clinical aspects. Berlin: Quintessence, pages 29-63,.
Ha, E. W.-W. (2009). Medizintechnik: Life Science Engineering. Springer Science &.
Hsuan-Yu Chou, J. J. (2008). Predictions of bone remodeling around dental implant systems. Journal of Theoretical Biology, 41:1365-1373.
Jennifer Paola Corredor-Gómez, A. M.-R.-R.-R. (2015). Modeling bone density changes due to dental implant thread rounding radii. IADR LAR. Bogotá Colombia.
Jennifer Paola Corredor-Gómez, C. J.-R. (2013). Biological 2D finite element analisys of a trabeculated dental implant. XIV International Symposium on Computer Simulation in Biomechanics. Natal, Brasil.
Jennifer Paola Corredor-Gómez, M. A.-M.-R.-A. (2012). Ponencia: Análisis bidimensional de geometrí as para tornillos de implantes dentales. TERCER CONGRESO EN INGENIERIA FÍSICA. Medellin,Colombia. 2012-09-01. Medellin, Colombia.
Jennifer Paola Corredor-Gómez, M. L.-D.-R. (2014). Biomechanical analysis of an implant placed in osteoporotic bone. 29th Annual Meeting of the Academy of Osseointegration. Seattle, Estados Unidos.
Luigi Baggi, I. C. (2008). Stress-based performance evaluation of osseointegrated dental implants by finite-element simulation. Simulation Modelling Practice and Theory, 16:971-987.
Misch, C. E. (2007). Contemporary implant dentistry. Elsevier Health Sciences.
Persson, G. C. (1967). Morphologic changes of the mandible after extraction and wearing. Odontologisk revy, 18(1):27.
Senichi Suzuki, H. K. (2013). Implant stability change and osseointegration speed of immediately loaded photofunctionalized implants. Implant dentistry, 22(5):481-490.
Straumann. (10 de 07 de 2017). Implantes Dentales Straumann. Obtained from website: straumann.es/es/acerca-de-straumann.html
Tallgren, A. (1966). The reduction in face height of edentulous and partially edentulous subjects during long-term denture wear a longitudinal roentgenographic cephalometric study. Acta Odontologica Scandinavica, 24(2):195-239.
Waldemar Mroz, B. B. (2015). In vivo implantation of porous titanium alloy implants coated with magnesium-doped octacalcium phosphate and hydroxyapatite thin films using pulsed laser depostion. Journal of Biomedical Materials Research Part B: Applied Biomaterials, 103(1):151-158,.
Wolff, J. (1893). Das gesetz der transformation der knochen. DMW-Deutsche Medizinische Wochenschrift, 19(47):1222-1224.
Zimmer-Biomet. (10 de 07 de 2017). Empresas de dispositivos médicos| Tecnologia médica| Zimmer Biomet. Obtained fromweb site: zimmerbiomet.com/es

All patents, patent applications and publications cited in this application including all cited references in those patents, applications and publications, are hereby incorporated by reference in their entirety for all purposes to the same extent as if each individual patent, patent application or publication were so individually denoted.

While the many embodiments of the invention have been disclosed above and include presently preferred embodiments, many other embodiments and variations are possible within the scope of the present disclosure and in the appended claims that follow. Accordingly, the details of the preferred embodiments and examples provided are not to be construed as limiting. It is to be understood that the terms used herein are merely descriptive rather than limiting and that various changes, numerous equivalents may be made without departing from the spirit or scope of the claimed invention.

1-13. (canceled)

14. A screw for dental implants comprising three sections, said three sections defined as coronal part zone A (1); middle part Zone B (2) and apical Zone C (3); and wherein said screw includes the following nine dimensional parameters for said three zones: coronal diameter (14) having dimensions between 4.6 mm and 5.2 mm; length (13) having dimensions between 8 mm and 14 mm; body angle 0°; pitch (18) having dimensions between 0.5 mm and 1.8 mm; coronal thread angle (16) between 750 and 95°; apical thread angle (15) between 65° and 85°; apical rounding (20) having dimensions between 0.35 mm and 0.65 mm; thread width (19) having dimensions between 0.25 mm and 0.55 mm; and thread depth (17) having dimensions between 0.35 mm and 0.65 mm.

15. The screw according to claim 14, wherein the coronal diameter (14) has dimensions between 4.8 mm and 5 mm; the length (13) has dimensions between 10 mm and 12 mm; the apical rounding (20) has dimensions between 0.45 mm and 0.55 mm; the thread width (19) has dimensions between 0.35 mm and 0.45 mm; and the thread depth (17) has dimensions between 0.45 mm and 0.55 mm.

16. The screw according to claim 14, wherein zone A (1) is the coronal portion including a thread for dental implants; zone B (2) is the implant body including all the threads except for the coronal and the apical portions of the screw for dental implants; and zone C (3) is the coronal portion that includes the apical thread of the screw for dental implants.

17. The screw according to claim 15, wherein the zone A (1) is the coronal portion that includes the coronal thread of the screw for dental implants; the zone B (2) is the implant body, which includes the intermediate threads of the body except for the coronal and the apical portion of the screw for dental implants; the zone C (3) is described as the most coronal portion that includes a thread, more specifically the most apical thread of the screw for dental implants.

18. The screw according to claim 14, wherein in the zone A the pitch (18) has dimensions in a range between 0.6 mm and 0.9 mm; the coronal thread angle (16) has in a range between 77° and 93°; the apical thread angle (15) has dimensions in a range between 67° and 83°.

19. The screw according to claim 15, wherein in the zone A the pitch (18) has dimensions in a range between 0.6 mm and 0.9 mm; the coronal thread angle (16) has dimensions in a range between 77° and 93°; the apical thread angle (15) has dimensions in a range between 67° and 83°.

20. The screw according to claim 16, wherein in the zone A the pitch (18) has dimensions in a range between 0.6 mm and 0.9 mm; the coronal thread angle (16) has dimensions in a range between 77° and 93°; the apical thread angle (15) has dimensions in a range between 67° and 83°.

21. The screw according to claim 18, wherein in the zone A the pitch (18) has dimensions between 0.7 mm and 0.8 mm; the coronal thread angle (16) has dimensions between 79° and 91°; and the apical thread angle (15) has dimensions between 69° and 71°.

22. The screw according to claim 14, wherein in the zone B the pitch (18) has dimensions in a range between 1.3 mm and 1.7 mm; the coronal thread angle (16) has dimensions in a range between 88° and 93°; and the apical thread angle (15) has dimensions in a range between 77° and 83°.

23. The screw according to claim 15, wherein in the zone B the pitch (18) has dimensions in a range between 1.3 mm and 1.7 mm; the coronal thread angle (16) has dimensions in a range between 88° and 93°; and the apical thread angle (15) has dimensions in a range between 77° and 83°.

24. The screw according to claim 16, wherein in the zone B the pitch (18) has dimensions in a range between 1.3 mm and 1.7 mm; the coronal thread angle (16) has dimensions in a range between 88° and 93°; and the apical thread angle (15) has dimensions in a range between 77° and 83°.

25. The screw according to claim 24, wherein in the zone B the pitch (18) has dimensions between 1.4 mm and 1.6 mm; the angle of the coronal thread (16) has dimensions between 89° and 91°; and the angle of apical thread (15) has dimensions between 79° and 81°.

26. The screw according to claim 25, wherein the zone B (2) can be subdivided into more portions depending on the bone quality.

27. The screw according to claim 25, wherein the zone B (2) can be subdivided into more portions depending on the bone quality.

28. The screw according to claim 14, wherein in the zone C the pitch (18) has dimensions in a range between 0.6 mm and 0.9 mm; the coronal thread angle (16) has dimensions in a range between 77° and 93°; and the apical thread angle (15) has dimensions in a range between 67° and 83°.

29. The screw according to claim 15, wherein in the zone C the pitch (18) has dimensions in a range between 0.6 mm and 0.9 mm; the coronal thread angle (16) has dimensions in a range between 77° and 93°; and the apical thread angle (15) has dimensions in a range between 67° and 83°.

30. The screw according to claim 16, wherein in the zone C the pitch (18) has dimensions in a range between 0.6 mm and 0.9 mm; the coronal thread angle (16) has dimensions in a range between 77° and 93°; and the apical thread angle (15) has dimensions in a range between 67° and 83°.

31. The screw according to claim 28, wherein in zone C the pitch (18) has dimensions between 0.7 mm and 0.8 mm; the angle of the coronal thread (16) has dimensions between 79° and 81°; the angle of apical thread (15) has dimensions between 69° and 71°.

32. The screw according to claim 14, wherein its configuration is non-helical, its configuration is totally axis-symmetric, and the threads are rings that are integral with a solid cylindrical body (4).

33. The screw according to claim 32, wherein its configuration is non-self-tapping, due to its axis-symmetric nature (4).
